(19) United States
(12) Patent Application Publication
(10) Pub. No.: US 2005/0154683 A1
(43) Pub. Date: Jul. 14, 2005

(54) Creating your home-software for builders

(76) Inventors: Marcus Lynn Dardy, Indianapolis, IN (US); Merri Lisa Dardy, Indianapolis, IN (US)

Correspondence Address: MARCUS L. DARDY, 12820 FREEDOM DRIVE, NOBLESVILLE, IN, 46060, US

(21) Appl. No.: 10/753,283

(22) Filed: Jan. 9, 2004

(51) Int. Cl. G06G 7/00

(52) U.S. Cl. 705/400

(57) ABSTRACT

The installation of the software for the builders should be written into memory. The user should receive a selection that indicates if he/she agrees to the contents of the agreement concerning the software. When the user agrees the software it is maintained as is.

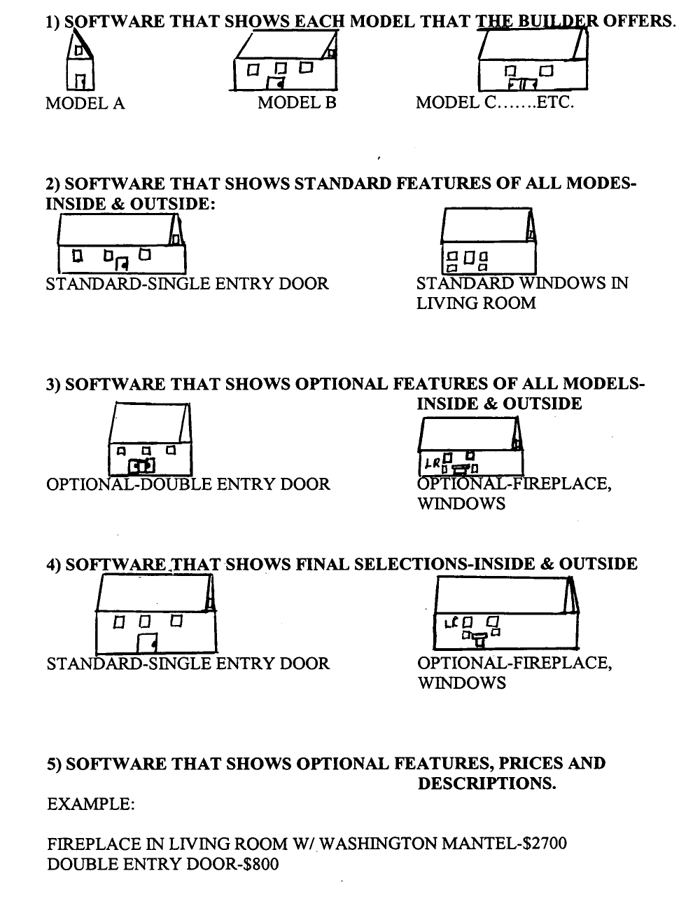

### CROSS REFERENCE

None

### STATEMENT OF FEDERALLY SPONSORED RESEARCH & DEVELOPMENT

None

### REF. TO SEQ. LISTING

### Table of Contents

Software that displays

1) Standard features of each model

2) Optional features of each model—inside & outside

3) Visual of the optional features

4) Visual of the final selections

5) Prices of the options

### BACKGROUND OF THE INVENTION

Experience of inventors purchasing and building a new home where the visuals were absent

### BRIEF SUMMARY OF INVENTION

Creation of software to show homeowner what the optional feature would look like on the type of model home that they select to build

### BRIEF DESCRIPTION OF SEV. VIEW OF DRAWINGS

See drawings page

### DETAILED DESCRIPTION OF THE INVENTION:

Create software that can be used by builders to show the homeowner visual selections of:
1) each model that is for sale
2) standard features on each model—inside & outside

1) We (Merri, Marcus Dardy) claim that the softwre we will create will be installed on the builders hardware (computers). The software will provide visuals of each model, optional features, standard features, final selection and prices of optional features for the potential homeowners.

2) This software is being created to be used by the builders only, not individuals outside the builders association.
